(19) United States
(12) Patent Application Publication
(10) Pub. No.: US 2008/0289002 A1
(43) Pub. Date: Nov. 20, 2008

(54) Method and a System for Communication Between a User and a System

(75) Inventors: Thomas Portele, Bonn (DE); Vasanth Philomin, Stolberg (DE); Christian Benien, Aachen (DE); Holger Scholl, Herzogenrath (DE); Frank Sasschenscheidt, Aachen (DE); Jens Friedmann Marschner, Wurselen (DE); Reinhard Kneser, Aachen (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 11/571,572

(22) PCT Filed: Jul. 1, 2005
(86) PCT No.: PCT/IB05/52193

§ 371 Date: Jan. 3, 2007

(30) Foreign Application Priority Data
Jul. 8, 2004 (EP) 04103242.6

(51) Int. Cl. G06F 21/00

(52) U.S. Cl. 726/2

(57) ABSTRACT

The present invention relates to a method of communication (113) between a user (101) and a system (103) where it is detected whether the user looks at the system or somewhere else, and based thereon adjusting the communication.

The present invention relates to a method of communication between a user and a system where it is detected whether the user looks at the system and based thereon the communication is adjusted.

In the last years there has been much process in developing systems for interacting with users. An example is a voice control communication where the user interacts with the system by commanding the system to perform different actions.

In US 20020105575 a method of enabling a voice control of a voice control apparatus is described where it is detected when the user is looking towards the apparatus. Only when it is detected that the user is looking towards the apparatus, a voice control is enabled. The main aim of this invention is to minimize the risk of unwanted activation of multiple voice-controlled apparatuses by the same verbal command.

The problem with this apparatus is that it does not treat events appearing in conversational interaction like short distraction by events unrelated to the conversation. This makes the communication between the user and the apparatus difficult and inflexible. Furthermore, the apparatus is not able to address the user actively upon detection of the user looking at the apparatus.

WO 03/096171 discloses a device comprising a pick-up means for recognizing speech signals. Also disclosed is a method of operating an electronic apparatus, which enables a user to operate with the device by means of speech control.

The problem with this invention is that, in order to interact with the system, a speech signal must be recognized. This can be problematic when the user's voice is different, e.g. because of sickness. Also this system does not treat events appearing in conversational interaction like short distraction by event unrelated to the conversation. This makes the whole interaction as such very stiff and unnatural.

A system exists where gaze is used as an attention indicator (K. Thorisson, “Machine perception of real-time multimodal natural dialogue”, Language, Vision & Music, 97-115, 2001) where eye gaze and body movements are analyzed in order to obtain the user's state of attention. The main use of this information is to determine, which objects are in the current focus of the user's attention.

The problem with this system is how demanding it is, since it must be physically mounted to the user's head with head-mounted cameras. In addition to this enormous inconvenience of using the system the interaction between the user and the system is limited and very unnatural.

It is the object of the present invention to solve the above mentioned problems.

According to one aspect the present invention relates to a method of communication between a user and a system, comprising:
detecting whether the user looks at the system, and based thereon
adjusting said communication.

Therefore, by detecting the user's state of attention the communication between the user and the system becomes very natural, unobtrusive and human like.

In an embodiment the method further comprises reacting towards the user as soon as the user's presence is detected.

This makes the communication between the user and the system more human like. As an example, the system could react towards the user by greeting the user when the user enters the room in which the device is situated. This can be compared to interaction between people, where a person is greeted when he/she comes home from work as an example.

In an embodiment the method further comprises reacting towards the user as soon as the user's identity has been detected.

Thereby, the security of the system is enhanced since the system will not react in any way if the detected user is unknown. Furthermore, personal profiles and preferences of the identified user can be used to further adjust the communication.

In an embodiment the method further comprises communicating with more than one user at the same time.

Thereby, the system can interact with more than one user at the same time without being forced to identify a new user each time that he/she wants to communicate with the system. The system can therefore distinguish, which one of several users is communicating by detecting, which user is looking at the system. This is similar to a person that is talking to more than one other person in the same room at the same time. This could as an example be a family, where each family member can e.g. ask the system to perform different actions, e.g. to check emails etc. That is why this makes the communication between the users, e.g. family members, and the system very human like.

In an embodiment the method further comprises initiating the communication between the user and the system based on the user's look towards the system.

Thereby, the communication is initiated in a very convenient and human like way, since the user's look towards the system should indicate the user's interest in initiating said communication. This is similar to a situation where one person wants to find out whether another person is willing to start a conversation. That person would typically indicate this by approaching the other person and look him/her into the eyes.

In an embodiment the method further comprises initiating the communication between the user and the system, when an event has occurred.

This improves the communication between the user and the system further. This event can as an example comprise receiving an email, or someone is ringing a bell, which is connected to the system. In that case the system could ask the user whether he/she may be interrupted because someone is ringing the bell. A telephone could even be integrated into the system, so that the system could inform the user that the phone is ringing and whether he/she wants to answer it. Preferably, the system first of all checks if the user is present in the room, or whether the user is engaged in another activity. If the user is looking at the system, he/she is willing to engage in a communication.

In an embodiment the method further comprises detecting the physical position of the user.

Therefore, the user is not forced to stay in the proximity of the system while communicating with it. As an example the user can lie on the sofa, or sit in a chair, while communicating with the system.

In an embodiment the method further comprises detecting an acoustic input.

Therefore, the system can further detect the user's acoustics or the acoustics from the surroundings and thereby communicate both via detecting whether the user looks at the system and also via said acoustics. This is of course the typical way of how people communicate.

In a further aspect the present invention relates to a computer readable medium having stored therein instructions for causing a processing unit to execute said method.

In one aspect the present invention relates to a system for communicating with a user, comprising:
a detection means for detecting whether the user looks at the system, and
a processor for adjusting said communication based on output data from said detection means.

Therefore, a conversational system is obtained, which enables the user to interact with the system in a very human like way.

In an embodiment the system further comprises an acoustic sensor for detecting an acoustic input.

Therefore, by detecting both the acoustic input and whether the user looks at the system, one could say that in a way the system has both “eyes” and “ears”. As an example the user can be looking at the system but not be responding to a dialogue between the user and the system for some time. This could be interpreted in a way that the user is no longer interested in participating in the dialogue with the system, and the communication could be stopped. In the same way, during an interaction, the user could be looking in another direction and not towards the system. Although the detection means would indicate that the user is not paying any attention, the dialogue conversation could indicate that the user is indeed still paying attention.

In the following the present invention, and in particular preferred embodiments thereof, will be described in more details in connection with accompanying drawing in which

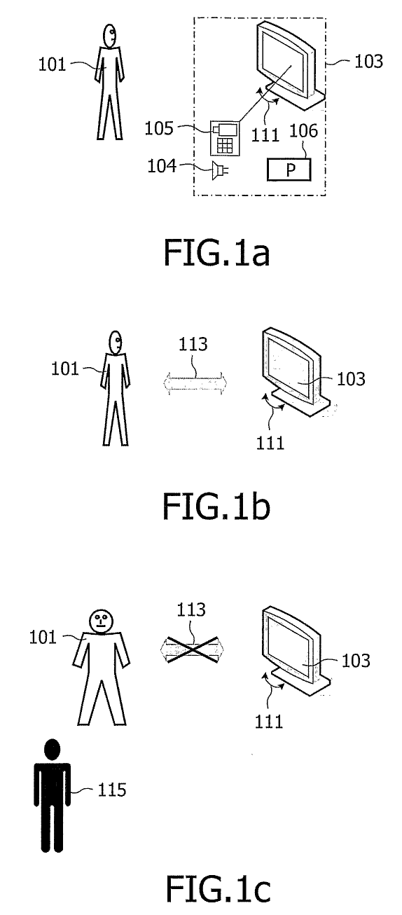

FIG. 1 shows a system 103 for communicating with a user, and

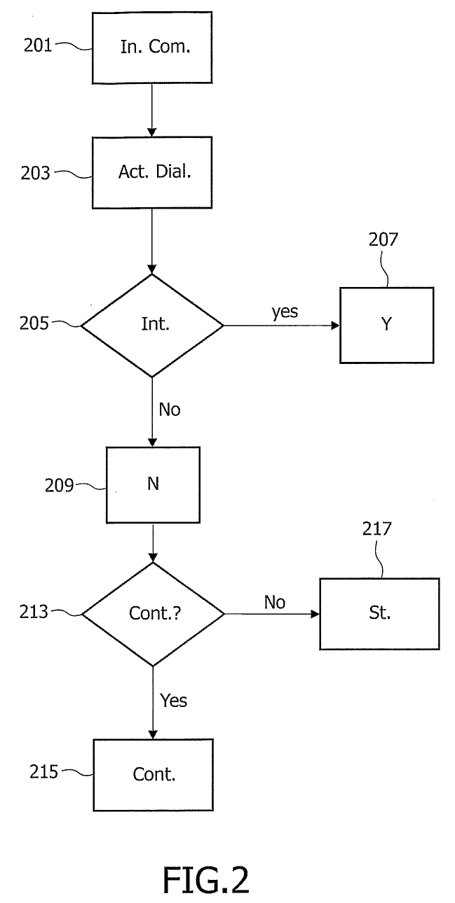

FIG. 2 illustrates a flow chart of a method of communication between a user and a system.

FIG. 1 shows a system 103 for communicating with a user 101, which in this embodiment is integrated into a computer. The system 103 comprises a detection means 105 that detects the presence and absence of the user 101, and whether the user 101 is looking at the system 103 or not, i.e. in this case towards the computer monitor. As shown here, the system 103 further comprises an acoustic sensor 104 for detecting an acoustic input from both the user 101 and the surroundings. The acoustic sensor 104 is, however, not an essential part for the present invention, and could easily be left out. Shown is also a processor 106 for adjusting the communication between the user 101 and the system 103 based on output data from the detection means 105 and the acoustic sensor 104. Furthermore, the system 103 can be provided with rotational equipment 111 for following the movement of the user 101 through a rotation. The detection means 105 could as an example be a camera comprising algorithms to perform said detection by scanning the user's face, and use one or more characteristics from the scanning to determine whether the user 101 is looking towards the system 103 or not. In a preferred embodiment the visibility of both eyes are detected to determine whether the face image is a frontal one. Therefore, a change in the user's look, e.g. the user grows a beard, does not affect the detection. Based on whether the user 101 is looking at the system 103 or not the user's attention towards the system is determined. Accordingly, when the user 101 looks towards the system 103 the detection means 105 interprets it so that the user is paying attention, and a communication between the system 103 and the user 101 is maintained. On the other hand, if the user 101 is not looking at the system 103 for some time, it may be interpreted by the detection means 105 as if the user 103 is not paying any attention. In a similar way the user's attention towards the system is determined by the acoustic sensor 104, which detects whether or not the user 101 is responding to a dialogue between the user 101 and the system 106 or a request. This request could be “are you interested in continuing with the dialogue”. If the user answer is “yes, I am interested in continuing with the dialogue” the acoustic sensor 104 detects it as if the user is paying attention. The processor 106 uses the interplay between the interpretation from the detection means 105 and the acoustic sensor 104, i.e. the interpretation on whether or not the user 101 is paying attention, to adjust the communication between the user 101 and the system 103. The adjustment could comprise stopping the communication 113 between the user 101 and the system 103, asking the user 101 whether he/she wants to continue with the dialogue or continue later with the dialogue.

In the example shown in FIG. 1a the user 101 is interested in establishing a communication with the system 103. As soon as the user 101 is detected by the system 103 it actively reacts, such as by greeting the user. In a preferred embodiment the system 103 actively reacts towards the user, if the user's identity has been detected. Otherwise, it does not react. This enhances the security of the system. Furthermore, personal profiles and preferences of the identified user can be used to further adjust the communication. Establishing a communication with the system 103 may be done by looking at the system 103 for a predefined time, e.g. 5 seconds. The detection means 105 then detects that the user 101 is, and has been, looking at the system 103 for some time. This is interpreted so that the user 101 is willing to engage in a conversation with the system 103, and a communication 113 is established as shown in FIG. 1b. The system 103 can also additionally ask the user 103 whether he/she is interested in establishing a communication with the system 103. This communication 113 is preferably maintained while the user 101 is still paying attention, either according to the acoustic sensor 104 or the detection means 105 or a combination of both. As an example the user 101 may not be looking directly towards the system 103 as shown in FIG. 1c because the user 101 is engaged in another activity, e.g. talking to another person 115 in the room. In this case the system could either interrupt the dialogue between the user 101 and the system 103 or ask the user 101 whether he/she wants to continue with the dialogue or not. If the user 101 does not respond to the question, the communication 113 may be stopped. Also, if the user 101 leaves the room, and the system 103 does no longer detect the presence of the user 101, the communication 113 and the system 103 may be shut down immediately, or after some predefined time since it is possible that the user 101 has to leave the room for a short while without breaking the connection 113.

In one embodiment the system can react and communicate with more than one user as soon as the user's identities are detected. The system can therefore distinguish, which one of several users is communicating, by detecting which user is looking at the system. Therefore the system has the ability to interact with more than one user at the same time without being forced to identify a new user each time that he/she wants to communicate with the system.

In one embodiment the system is further provided with a speech recognition module with voice activity analyses. Therefore, the user's voice could be detected and distinguished from other voices or sounds.

In one embodiment the system 103 further determines the position of the user 101, and preferably detects whether the user 101 is looking at the system 103 or not. Therefore, the user 101 is not forced to stay at the same position when communicating with the system 103 and can therefore, e.g. lie on the sofa, or sit in a chair, while communicating 113 with the system 103 as described above.

In one embodiment the location of the acoustic input is calculated by the system 103 e.g. by beam forming system (not shown) and compared to the position of the user 101. Therefore, if the acoustic input differs from the location of the user 101, e.g. is coming from a TV, the system can ignore it and continue with the dialogue with the user 101.

In one embodiment the system 103 initiates a communication 113 with the user 101, e.g. a dialogue, if an event has occurred. This event can as an example comprise receiving emails, or someone is ringing a bell, which is connected to the system. The system 103 then checks whether the user 101 is present in the room, whether the user 101 is engaged in another activity, or whether the user 101 is talking. As an example, the system 103 could politely ask the user 101 whether he/she may be interrupted because someone is ringing the bell. In this case an external camera could be provided that detects who is ringing the bell, and the image of the person that is ringing the bell could, if requested by the user by the user's look or by the user's speech, be displayed on the monitor shown in FIG. 1.

In one embodiment the system 103 comprises additional subsystems, which are as an example distributed in different rooms or different areas in the user's 101 apartment. Therefore, each subsystem continuously monitors the presence of the user 101. The subsystem that detects the user's 103 presence continues with the communication. Therefore, the user 101 can, while communicating 113 with one subsystem, walk around in his/her apartment. As an example the user communicates with the subsystem in the living room after the subsystem has identified the user. When the user walks out of that room and into the bedroom, the system in the bedroom detects the user's presence, identifies him and continues e.g. with the dialogue. This can also be done for several users, which are moving around in the house.

In one embodiment the system 103 is provided with a speech recognition system (not shown), which computes a confidence level. This value gives an indication of how sure the recognizer is about its hypothesis. As an example, this value would be low e.g. if there is a lot of background noise. Preferably, a threshold is used, and input with a confidence value below this threshold is then discarded. If the user 101 looks at the system 103, this threshold would be lower, whereas if the user 101 does not look directly towards the system 103, the threshold is higher, and the system 103 must be very confident to do an action.

Of course the system 103 as described can be integrated into various equipment in stead of the computer as shown in FIG. 1. As an example, the system 103 can be integrated into a device that is mounted to a wall, or a device that is portable, so that the user 101 can move it from one place to another, depending on where the user 101 is situated. Also, the system 103 could be integrated into a robot or portable computers or any kind of electrical devices such as TV.

FIG. 2 illustrates a flow chart of an embodiment of a method of communication between a user and a system. Initially the communication between the user and the system is initiated (In. Com.) 201. This may be done by simply looking at the system for a predefined period of time. When the system detects that the user has been looking at the system for some time, e.g. 5 seconds, a connection is established between the user and the system, and a communication between the user and the system can be initiated (Act. Dial.) 203. The system continuously checks whether the user is looking towards the system (nt.) 205, such as by focusing on the user's eyes. If the user is not looking towards the system (N) 209, it is possible that the communication will be broken. If the interpretation is such that the user is not paying attention, the system may further be adapted to ask the user whether he/she wants to continue with the dialogue or not (Cont.?) 213. If the user does not respond to the question, or the answer is “no”, the communication is stopped (St.) 217. Also, if the user leaves the room, and the system does no longer detect the presence of the user, the communication is stopped (St.) 217. Otherwise, if the user answers by “yes” and/or or looks towards the system, the dialogue is continued (Cont) 215.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

1. A method of communication (113) between a user (101) and a system (103), comprising:
detecting whether the user (101) looks at the system (103), and based
thereon
adjusting said communication (113).

2. A method according to claim 1, further comprising detecting the physical position of the user (101).

3. A method according to claim 1, further comprising reacting towards the user (101) as soon as the user's presence is detected.

4. A method according to claim 1, further comprising reacting towards the user (101) as soon as the user's identity has been detected.

5. A method according to claim 1, further comprising communicating with more than one user (101) at the same time.

6. A method according to claim 1, further comprising initiating the communication (113) between the user (101) and the system (103) based on the user's look towards the system (103).

7. A method according to claim 1, further comprising initiating the communication (113) between the user (101) and the system (103) when an event has occurred.

8. A method according to claim 1, further comprising detecting an acoustic input (104).

9. A computer readable medium having stored therein instructions for causing a processing unit to execute method of claim 1.

10. A system (103) for communicating with a user (101), comprising:
a detection means (105) for detecting whether the user (101) looks at the
system (103), and
a processor (106) for adjusting said communication (113) based on
output data from said detection means (105).

11. A system (103) according to claim 10, further comprising an acoustic sensor for detecting an acoustic input (104).
